(19) United States
(12) Patent Application Publication
(10) Pub. No.: US 2002/0106616 A1
(43) Pub. Date: Aug. 8, 2002

(54) System for providing training in semiconductor manufacturing system operation techniques

(76) Inventors: Minoru Nakano, Tokyo (JP); Tsuyoshi Saito, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/052,774

(22) Filed: Jan. 23, 2002

(30) Foreign Application Priority Data
Jan. 24, 2001 (JP) 2001-015859

(51) Int. Cl. G09B 19/00

(52) U.S. Cl. 434/219

(57) ABSTRACT

A system for providing training in semiconductor manufacturing system operation techniques in which a system training server and a user terminal are interconnected via a circuit is provided in which the system training server stores at least one program for conducting simulation related to a semiconductor manufacturing system, receives simulation condition data related to the semiconductor manufacturing system that were input to the user terminal by the user and transmitted from the user terminal via the circuit, executes the stored program based on the received condition data, and transmits result data of the simulation conducted by the executed program to the user terminal via the circuit. Since the user is therefore trained by providing the user with the result data through the user terminal, effective training can be conducted.

### BACKGROUND OF THE INVENTION

1. Field of the Invention

This invention relates to a technology for training the user (owner and owner personnel) of a semiconductor manufacturing system in its operation by means of remote instruction over a communications circuit, particularly to a system for providing a user with training in semiconductor manufacturing system operation techniques via a user terminal connected to a system training server over a communications circuit.

2. Description of the Prior Art

A semiconductor manufacturing system is used for the manufacture of semiconductor wafers for semiconductor devices, glass substrates for LCDs (liquid crystal displays), and the like. In a CVD (chemical vapor deposition) system, for example, a silicon wafer or other substrate is placed in a heating furnace and a thin film such as an oxide film or a nitride film is formed on the substrate by supplying reaction gas into the heating furnace as the interior of the heating furnace is heated to a prescribed temperature. Such films are, for instance, used as interlayer insulating films or for protecting the surfaces of LSI (large scale integrated circuit) chips.

Such semiconductor manufacturing systems are generally built by assembling thousands of functional components, and the user (the term “user” herein referring to the company that purchased the system and, in many contexts, also the company's personnel in charge of operating the system) needs to be trained in the operation of the controller for operating the system. The companies that make semiconductor manufacturing systems therefore offer training in system use. This training falls generally into two categories. One is manual-based instruction utilizing mainly a manual and other printed media for imparting knowledge about, and methods of using and operating, semiconductor manufacturing system. The other is hands-on training, involving actual operation of the semiconductor manufacturing system, aimed at teaching operational and other system operation techniques.

An example of the flow of procedures in conventional training in semiconductor manufacturing system operation techniques is shown in FIG. 11.

The procedure starts with purchase of semiconductor manufacturing system by the customer (user). Then, when an application for training is received from the customer, a check is made to confirm that the party submitting the application is actually a customer (purchaser). When the customer has been verified, the manufacturer makes arrangements for the customer's trainees to come to its training center, where they are given manual-based and hands-on training. Such manual-based and hands-on training is usually provided free of charge for a specified period following purchase of the semiconductor manufacturing system and, after the free period has expired, is offered for a fee. At the end of the course, the trainees/owner are tested for mastery of the knowledge, techniques and skills taught during the training and the training is then concluded.

This training system requires customer trainees to come to the system manufacturer's training center to receive up-to-date technical information, training and the like. As customers who use semiconductor manufacturing systems are scattered around the globe, however, the amount of money, time etc. spent for traveling to and from the training center is often considerable. Moreover, the fact that the training must be completed within a fixed period has tended to make the training less complete than might be desired.

This invention was accomplished in light of these circumstances and has as an object to provide a system for offering users training in semiconductor manufacturing system operation techniques that provides the user with semiconductor manufacturing system operation technique training utilizing a user terminal connected to a system training server via a circuit. Other objects of the present invention are to provide such a system capable offering customers of semiconductor manufacturing systems anywhere in the world timely training in the latest techniques, to eliminate much of the travel and related expense required in connection with such training up to now, and to shorten the time needed for the training.

While no information on prior art related to training in the field semiconductor manufacturing systems is available, the following educational methods for conducting courses over the Internet have been developed.

Unexamined Japanese patent application JP-A-10-134028, for example, teaches a remote teaching method and system utilizing the Internet for supplying the subscriber with instruction data and evaluation data via the Internet.

Unexamined Japanese patent application JP-A-11-249540, for example, teaches a remote teaching system with learning capability that connects an educational server with a client PC of the student via the Internet. In this system, the server acquires information on the student's educational background that it uses to reorganize the curriculum into an optimum one for the student.

Unexamined Japanese patent application JP-A-11-282826 teaches an electronic educational system utilizing the Internet that connects a terminal of an educational services provider and a terminal of a student terminal with an electronic educational server via the Internet. In this system, the electronic educational server provides services such as downloading of educational contents (materials) from the educational services provider terminal and uploading screens of multimedia educational material prepared using the downloaded data to the student terminal.

### SUMMARY OF THE INVENTION

The present invention achieves the foregoing objects by providing a system for providing training in semiconductor manufacturing system operation techniques in which a system training server and a user terminal are interconnected via a circuit and the system training server trains the user in semiconductor manufacturing system operation techniques through the user terminal.

The system training server comprises a program storage means for storing a program for conducting simulation related to a semiconductor manufacturing system, a condition data receive means for receiving simulation condition data related to a semiconductor manufacturing system that were input to the user terminal by the user and transmitted from the user terminal via a circuit, program execution means for executing the program stored in the program storage means based on the received condition data, and result data transmission means for transmitting result data of the simulation conducted by the executed program to the user terminal via the circuit.

By supplying the user with the simulation result data through the user terminal, the system for providing training in semiconductor manufacturing system operation techniques configured in the foregoing manner can train the user in semiconductor manufacturing system operation techniques.

Timely training in the latest techniques can therefore be offered to semiconductor manufacturing system customers located throughout the world. In addition, the need for much of the travel and related expense associated with such training up to now can be eliminated and the time needed for the training can be shortened. Moreover, the system training server conducts simulation based on condition data input to the user terminal by the user and the simulation result data are supplied to the user through the user terminal, i.e., the training is provided utilizing interactive communication. The user can therefore be trained more effectively than in the case of merely transmitting data (e.g., a manual) from the system training server to the user terminal.

Further, the system training server can be configured to acquire information regarding the results of the user training. Thus, if the system training server is made capable of accruing and managing this information separately for each user, or if a management server having such information accruing and managing capability is installed on a network, the accrued and managed information can be used to ascertain the needs of the user and/or to help maintain product quality and develop new products (semiconductor manufacturing systems, training systems and the like). Moreover, in the system of the present invention, the simulation program is stored and executed on the system training server side. The advantage of this is that it enables the user to enjoy the benefits of a large-scale simulation program that puts a heavy load on memory and other resources while keeping the burden on the user terminal side equipment at a minimum. Thus the system configuration according to the present invention, which conducts simulation on the side of the system training server connected to the user terminal via a circuit, is very effective from the viewpoint of both the system manufacturer that offers the training and the user that receives it.

The system training server can be any of various types. Specifically, it can be a computer or the like.

Likewise, the terminal on the user side (the user terminal) can also be any of various types. Specifically it can be a computer or the like.

The circuit can also be any of various types. It can, for example, be a network such as the Internet.

The user is generally an organization, typically a company, that purchased a semiconductor manufacturing system, more specifically the personnel in the organization who operate the semiconductor manufacturing system.

The training in semiconductor manufacturing system operation techniques can be any of various types.

The simulation related to semiconductor manufacturing system can be any of various types of simulation suitable for the type of training offered.

The program or programs are required to be capable of conducting simulation related to semiconductor manufacturing system but are not otherwise limited in any way. For example, programs compiled any of various languages can be used.

The program storage means can, for example, be configured as a memory.

The program execution means can, for example, be configured as a processor such as a CPU (central processing unit) or MPU (microprocessor unit).

The simulation condition data related to a semiconductor manufacturing system can be data related to any of various conditions. For example, it can be data indicating the type of semiconductor manufacturing system, data indicating temperature, pressure and other condition values, or the user identification data referred to later. The condition data can include data indicating a condition related to only a single item (such as temperature or pressure) or can include data indicating conditions related to a number of items.

The user uses the user terminal by, for example, manipulating a user terminal input means (e.g., a keyboard or mouse) to enter input and/instructions to the user terminal such as the aforesaid condition data, training data request data (explained later), user identification data (explained later) and the like. The user terminal is equipped with transmit means for transmitting data received by input from the user to the system training server via a circuit.

Program execution is handled differently depending on the nature of the condition data. For example, when the condition data include a condition for selecting a program, a program matching the condition is selected and executed, and when the condition data include a condition to be used when executing the program (e.g., data to be used by the program or a value to be substituted for a program variable), the program is executed using that condition.

The result data from the simulation conducted by the executed program can be any of various types of data. For instance, the data obtained as a result of executing the program can be sent to the user terminal without modification or, alternatively, the data obtained as a result of executing the program can first be subjected to processing (enhancement processing or the like) by the system training server and the processed data be sent to the user terminal as the result data.

In a preferred configuration of the system for providing training in semiconductor manufacturing system operation techniques according to the present invention, the program storage means stores programs for conducting simulation related to semiconductor manufacturing systems that are associated with two or more types of semiconductor manufacturing systems, the condition data received by the condition data receive means include semiconductor manufacturing system type-designation data, and the program execution means executes a program associated with the type-designation data.

Therefore, in a case where two or more types of differently configured semiconductor manufacturing systems are used by one or more users, the program associated with the particular type of semiconductor manufacturing system designated from among the two or more types by the condition data is executed to conduct simulation. The user(s) can therefore be provided with training in the use of any of the different types of semiconductor manufacturing systems.

The types of semiconductor manufacturing systems among the two or more types are in no way limited.

The semiconductor manufacturing system type-designation data can be any of various data enabling identification of the type of semiconductor manufacturing system concerned.

The programs associated with the different type-designation data are programs installed for conducting simulation related to the types of semiconductor manufacturing systems designated by the type-designation data.

A preferred configuration of the system for providing training in semiconductor manufacturing system operation techniques according to the present invention is additionally equipped with manual data storage means for storing manual data related to a semiconductor manufacturing system, manual data request data receive means for receiving manual data request data that were input to the user terminal by the user and transmitted from the user terminal via a circuit, and manual data transmit means for retrieving from the manual data storage means manual data requested by the received manual data request data and transmitting them to the user terminal via the circuit.

Therefore, by conducting simulation related to the semiconductor manufacturing system, it is possible to offer the user virtual hands-on training in operation of the semiconductor manufacturing system, while, by supplying the user with manual data related to the semiconductor manufacturing system, it is possible to offer the user manual-based training in use of the semiconductor manufacturing system.

The manual data related to the semiconductor manufacturing system can include various data related to factual content for inclusion in a manual, specifically content data for a semiconductor manufacturing system user's manual, content data for a semiconductor manufacturing system operating manual, content data explaining general matters concerning the semiconductor manufacturing system, and other similar content data.

The manual data storage means can, for example, be configured as a memory.

The manual data request data can be any of various kinds of data for requesting manual data. Specifically, the manual data request data can be used to request specific data among the manual data stored in the manual data storage means (e.g., data related to a certain subject, data from a certain page, or heading data or the like). The manual data request data can also be used to request nonspecific data such as all manual data stored in the manual data storage means (supplied to the user in page order, for example).

The system training server of the system for providing training in semiconductor manufacturing system operation techniques according to the present invention can include user identification data receive means for receiving user identification data that were input to the user terminal by the user and transmitted from the user terminal via a circuit, user verify means for verifying a user based on the user identification data, and access restrict means for restricting user access based on the verification result.

Since it is therefore possible to ensure that the simulation-based training and the manual data-based training are carried out only with respect to users who have been verified as a properly registered users, unauthorized access by unregistered parties can be prevented and secrecy protection assured. In addition, the programs and data that each user is permitted to access can be restricted by, for example, defining the programs and data that can be accessed individually for each user.

The user identification data can be any of various types of data that enable users to be identified. Examples include, user name data, password data, or a combination of user name data and user password data.

Methods usable for verifying a user based on the user identification data include that of storing in advance data identical to the user identification data defined for properly registered users and conducting user verification by checking whether the user identification data received from a user matches the data stored for the same user. When the data are found to coincide, the user concerned is ordinarily judged to be an authorized user.

The system training server of the system for providing training in semiconductor manufacturing system operation techniques according to the present invention can further include expiration date data storage means for storing data designating the expiration date of a valid period of user access, in which case the access restrict means restricts user access based on the result of verification by the user verify means and the expiration date data stored in the expiration date data storage means.

This makes it possible, for example, to establish a valid period of user access (hereinafter called the “valid user access period”) during which a user is permitted to access the programs and manual data related to the semiconductor manufacturing system, to permit user access during the valid user access period, and to deny access once the expiration date has passed. For example, each user can be granted access to free training during the valid user access period established for the user concerned and denied access to the free training but permitted access to fee-based training upon payment of a fee after the expiration of the valid user access period.

The expiration date data are at least data defining a time limit of the period during which the user is permitted access and can, for instance, include both the data defining the time limit and data defining the area of access subject to the time limit.

The expiration date data storage means can, for example, be configured as a memory.

The system for providing training in semiconductor manufacturing system operation techniques according to the present invention can be configured to encrypt the data transmitted between the system training server and the user terminal on the transmission side and decrypt the data on the receiving side.

This makes it possible to prevent unregistered parties from making unauthorized use of the data transmitted between the system training server and the user terminals, thereby ensuring secrecy protection.

The encryption and decryption can be conducted with respect to all transmitted data or only with respect to part of the transmitted data.

The encryption can be conducted by any of various methods. The decryption on the receiving side is conducted by a method suitable for decrypting the data encrypted on the transmission side.

### BRIEF EXPLANATION OF THE DRAWINGS

FIG. 1 is a diagram showing a system for providing training in semiconductor manufacturing system operation techniques that is an embodiment of the present invention.

FIG. 2 is a diagram showing another system for providing training in semiconductor manufacturing system operation techniques that is an embodiment of the present invention.

FIG. 3 is a block diagram showing an example of the configuration of an system training server.

FIG. 4 is a diagram schematically illustrating an example of operation of the system for providing training in semiconductor manufacturing system operation techniques.

FIG. 5 is a diagram showing an example of a procedure for applying for training.

FIG. 6 is a diagram showing an example of a training application (signup) screen.

FIG. 7 is a diagram showing an example of a training comer entry screen.

FIG. 8 is a diagram showing an example of a training comer screen.

FIG. 9 is a diagram showing an example of the training comer screen of a basic manual-based course.

FIG. 10 is a diagram showing an example of the training comer screen of a basic simulation-based course.

FIG. 11 is a chart showing an example of the flow of procedures in conventional training in semiconductor manufacturing system operation techniques.

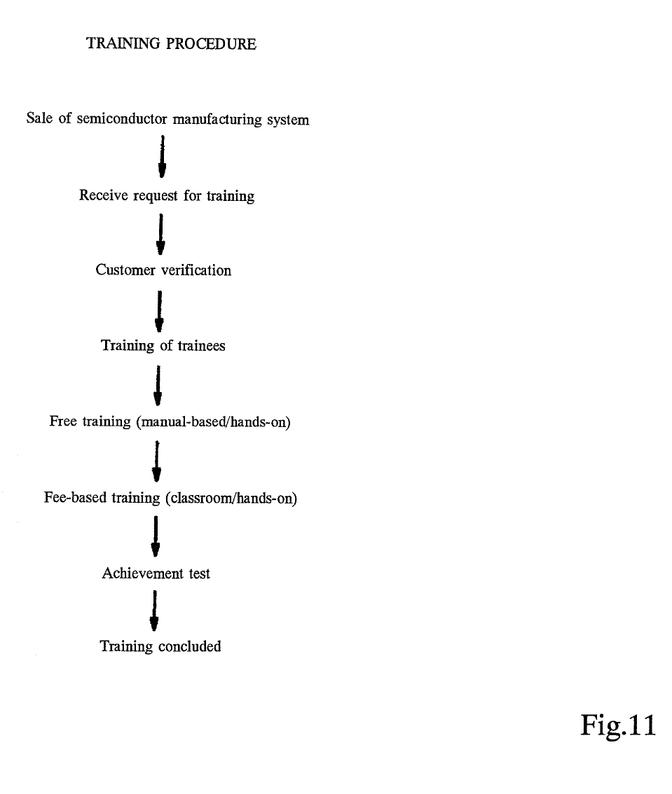

### DESCRIPTION OF THE PREFERRED EMBODIMENTS

A system for providing training in semiconductor manufacturing system operation techniques that is an embodiment of the present invention will now be explained with reference to the drawings.

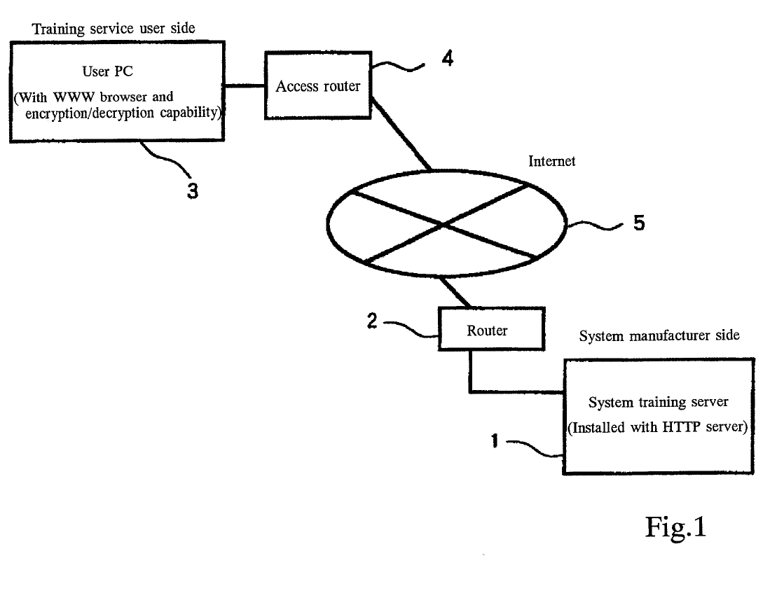

FIG. 1 shows a system for providing training in semiconductor manufacturing system operation techniques that is an embodiment of the present invention. This system is equipped with a system training server 1, router 2, user PC (personal computer) 3, access router 4 and network (the Internet) 5. In this embodiment, the user PC 3 and the system training server 1 are located at sites separated by a substantial distance.

The system training server 1, which is managed by the manufacturer that supplied (manufactured and sold) semiconductor manufacturing system to the user, is a server for providing the user (customer) with training. (The term “manufacturer” is used herein to include a party to which the actual producer of the system has subcontracted management of the system training server 1.) The system training server 1 is installed with a HTTP (hypertext transfer protocol) and is connected with the Internet 5 through a router 2.

The user PC 3, used by a customer (user) who purchased a semiconductor manufacturing system from the manufacturer, is a terminal that the user utilizes to receive training. The user PC 3 is installed with a WWW (World Wide Web) browser and an encryption/decryption program and is connected to the Internet 5 through the access router 4. The user PC 3 can access the system training server 1 over the Internet 5, transmit data to the system training server 1 via the Internet 5, and receive data transmitted from the system training server 1 via the Internet 5.

For convenience of explanation, this embodiment will be described with respect to a system having only one user PC 3. It will be readily understood by those skilled in the art, however, that it is possible to connect a number of user PCs used by different users to the Internet 5 and enable them to utilize the system training server 1.

The access router 4 is equipped with a modem when utilizing a public telephone circuit or with a terminal adapter when utilizing an ISDN (integrated services digital network).

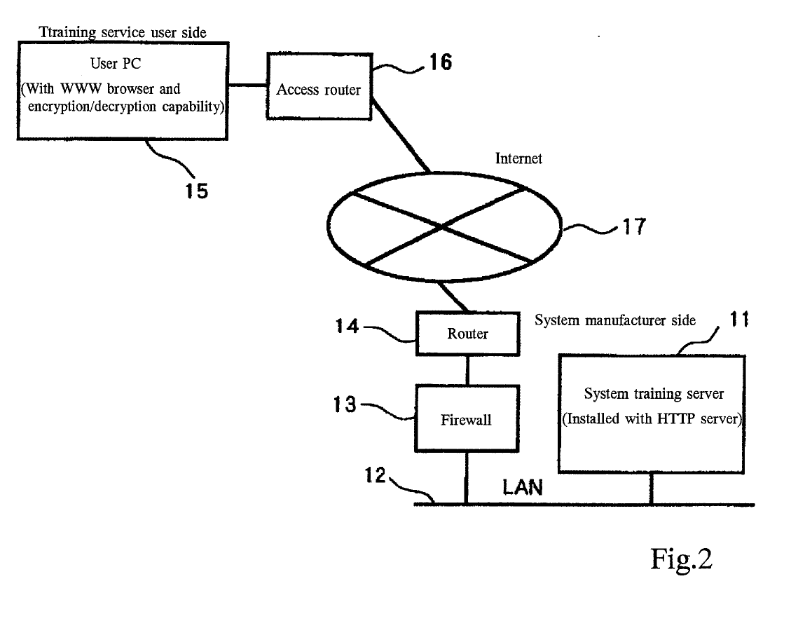

Although this embodiment will be explained with respect to a system for providing training in semiconductor manufacturing system operation techniques configured as shown in FIG. 1, it is also possible to configure a system for providing training in semiconductor manufacturing system operation techniques in which, as shown in FIG. 2, a LAN 12 and the Internet co-reside.

In the system configuration of FIG. 2, a system training server 11 is connected to a firewall 13 through a LAN (local area network) 12 (an internal LAN of the manufacturer) and the firewall 13 is connected to the Internet 17 through a router 14. On the side of the user of the training service, a user PC 15 is connected to the Internet 17 through an access router 16.

In the system configuration of FIG. 2, the access control and encryption functions are partially incorporated in the firewall 13. The firewall 13 is equipped with a gateway facility dedicated to access control, an IP (Internet protocol) security facility , a HTTP and other service port security facilities, an encryption facility for VPN (virtual private network) connection, and an access logging facility.

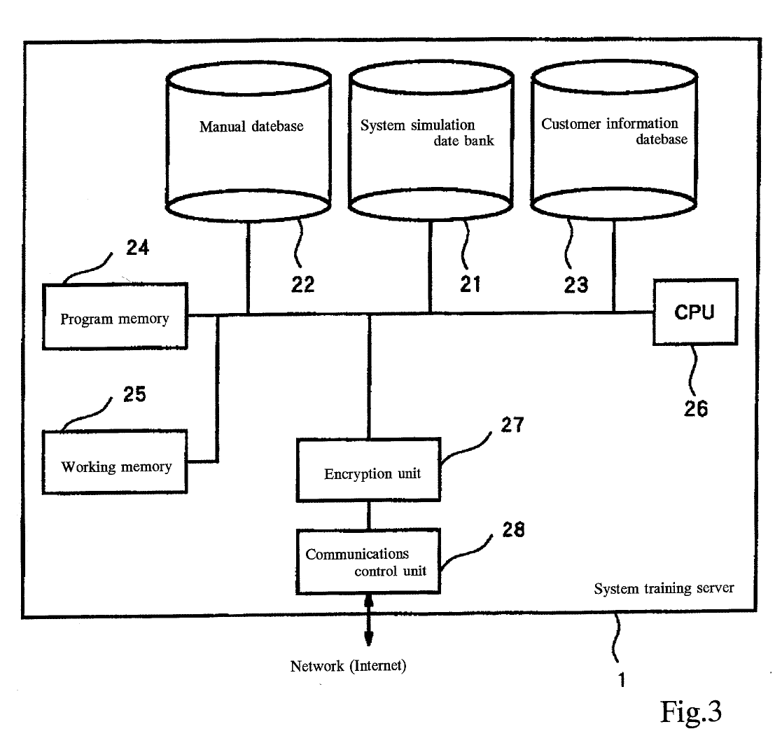

FIG. 3 shows the configuration of the system training server 1. The system training server 1 of this embodiment is equipped with a system simulation database 21, manual data database 22, a customer information database 23, a program memory 24, a working memory 25, a CPU 26, an encryption unit 27 and a communications control unit 28. The communications control unit 28 is connected through the router 2 to a communications circuit (the Internet 5 in this embodiment).

The system simulation database 21 stores program and other data used for conducting simulation related to the semiconductor manufacturing system (e.g., data for system simulation for supplementing hands-on instruction for teaching operations and the like through actual semiconductor manufacturing system operation). The system simulation database 21 is compiled using various browser-compatible languages such as HTML (hypertext mark-up language), JavaScript, Java and ActiveX.

The contents of the simulation related to the semiconductor manufacturing system include, for instance, “Recipe formulation and implementation simulation,” “Mechanical operation simulation,” “Gas inflow and exhaust simulation,” “Pressure regulation simulation,” Temperature regulation simulation,” “Film growth simulation,” and “Trouble and troubleshooting simulation.”

The constitution (type) of the semiconductor manufacturing system generally varies among customer companies and each type of system usually includes aspects that the customer concerned considers confidential.

Differences in system constitution include process-related differences in both the oxidation-diffusion equipment and the CVD equipment such as “Wafer size,” “Number of wafers,” “Film type,” “Purpose in device,” “Equipment type,” “Required number of batches,” “Wafer positioning,” “Rod temperature, “Unload temperature,” “Temperature increase rate,” “Temperature decrease rate,” and “Temperature control during temperature increase/decrease,” processing-related differences in only the oxidation-diffusion equipment such as “Oxidation (anneal) temperature, gas flow rate (ratio) during oxidation, and other required conditions in individual steps,” and process-related differences in only the CVD equipment such as “Desired film thickness,” “Deposition temperature,” “Deposition temperature,” “Deposition pressure,” “Gas flow rate (ratio) during deposition,” and “Other required conditions.”

Differences in system constitution include system component-related differences in mechanical components such as “Elevator,” “Cassette loader,” “Cassette stage (orientation-flat/notch)” “Cassette band,” “Transfer system” and “Boat rotating system,” in electrical components a such as “Diffusion controller,” “Temperature controller unit,” “Overheating protection unit,” “Thermocouple,” “Temperature controller unit (vacuum gauge)” and “MFC (MFM),” and software components such as “Block control,” “Tube control,” “Mechanical control,” “Gas pressure control” and “Temperature control.”

In this embodiment, in order to accommodate difference in semiconductor manufacturing system configuration among different customers (or, when required, different plants or different production lines of the same customer), the nature of the training that each customer (or, if required, each customer plant or production line) can apply for (substance of the manual-based instruction or virtual hands-on instruction) is controlled and the nature of the training that each customer (or, if required each customer plant or customer production line) can receive is restricted based on the password assigned.

The manual data database 22 stores manual data related to the semiconductor manufacturing system (knowledge, methods of use, and other manual-based instruction related data used mainly in the form of printable media). Such manual-based instruction data is compiled chiefly in HTML language to enable the user to create links to required information and thus enhance user learning effect. User learning effect can, for example, be increased by offering manual data composed of multimedia data combining voice/sound data, graphic data and text data.

Topics covered by the manual data related to semiconductor manufacturing system include, for example, “Structure and operation of mechanisms,” “How interlocking works,” “Power supply circuitry,” “Control system,” “Basics of temperature control,” “Burn-box structure and H₂ burn-in method,” and “Safety with 4% annealing.”

The manual data database 22 encompasses sub-databases for individual types of semiconductor manufacturing systems that cover subjects related to the special specifications of different types of semiconductor manufacturing systems. The sub-databases store manual data on such topics as, for example, “System structure,” “Mechanical drive sections and shaft adjustment,” “Operation using the handy terminal,” “Setting movement parameters,” Operating the cassette loader” and “Structure of external burn-in equipment.”

The manual data database 22 also stores data for use in ascertaining user learning effect. These include, for instance, “Standardized comprehension test (basic)” related to semiconductor manufacturing system and “Expert comprehension test (advanced)” related to semiconductor manufacturing system.

In this embodiment, user training is conducted using required data retrieved from the system simulation database 21 and the manual data database 22.

The customer information database 23 stores data related to the customer (company that purchased semiconductor manufacturing system, the system user etc.) and handles such jobs as “Customer address management,” “Customer training period management,” “Customer billing data management” and “Customer access history management.” This embodiment conducts customer training period management for controlling whether users are offered free training or fee-based training.

This embodiment also uses the customer information database 23 to collect and manage data related to user training results. By displaying the collected information on a screen (not shown) and/or preparing hard copies with a printer (not shown), the manufacturer can ascertain how individual users are using their semiconductor manufacturing systems and determine what capabilities and performance users want from their semiconductor manufacturing systems. This helps the manufacturer to provide users with better service and make decisions regarding future product development.

The program memory 24 stores programs for conducting various types of processing in the system training server 1. While program data for conducting simulation related to semiconductor manufacturing systems are stored in the system simulation database 21 in this embodiment, all or part of such data can instead be stored in the program memory 24.

The working memory 25 is a memory area that the CPU 26 explained below uses to execute programs.

The CPU (central processing unit) 26 executes various processing and various control in the system training server 1. Specifically, it loads programs stored in the program memory 24 and the system simulation database 21 into the working memory 25 and executes them to conduct the various kinds of processing and control performed by the programs. Such processing and control is, as required, conducted using the data (non-program data) stored in the system simulation database 21, the manual data database 22 and the customer information database 23.

The encryption unit (access control unit) 27 utilizes an encryption system (one using public and private keys, for example) to prevent unauthorized access. In the present embodiment, the user PC 3 side is installed with an encryption system with the same capabilities. The encryption unit 27 verifies the user for access using user ID and password data, restricts access based on the IP addresses used by users receiving training, restricts access of users receiving training solely to access for receiving HTTP and other specified services, monitors user training period, cancels the access authorization of a user whose valid user access period has expired, and uses an installed access logging feature to monitor unauthorized access and abnormal access.

The communications control unit 28 is dedicated to handling data traffic. Specifically, in connection with Ethernet control, it conducts MAC address control, carrier signal detection and transmission queuing, collision detection, and retransmission after collision. In connection with the control of various IP settings, it conducts IP address control, sub-network address control, default router control, routing control, name service control, and IP and MAC address table control. In connection with TCP (transmission control protocol)/IP control, it conducts TCP port connection, send/receive timeout control, retransmission control, congestion control, send/receive sequence control and window size control.

The system for providing training in semiconductor manufacturing system operation techniques according to the present embodiment includes the following features and capabilities according the present invention. These will be explained I'm not conjunction with those set out above.

The system training server 1 of the present embodiment corresponds to the system training server of the present invention and the user PC 3 corresponds to the user terminal of the present invention. The system training server 1 and the user PC 3 are connected through a circuit (the Internet 5 in this embodiment) and the system training server 1 provides the user with semiconductor manufacturing system operation training through the user PC 3.

The system training server 1 has a program storage facility for storing programs for conducting simulation related to semiconductor manufacturing systems, a condition data receive facility for receiving simulation condition data related to a semiconductor manufacturing system that were input to the user PC 31 by the user and transmitted from the user terminal via the Internet 5, a program execution facility for executing programs stored in the program memory in response to the received condition data, and a result data transmission facility for transmitting data resulting from the simulation carried out by the executed program to the user PC 3 over the Internet 5. In the present embodiment, user semiconductor manufacturing system operation training is implemented by providing such result data to the user through the user PC 3.

In the present embodiment, the program storage facility corresponds to the program storage means of the present invention and is implemented by the system simulation database 21.

In the present embodiment, the condition data receive facility corresponds to the condition data receive means of the present invention and is implemented by the communications control unit 28.

In the present embodiment, the program execution facility corresponds to the program execution means of the present invention and is implemented by the CPU 26 and the working memory 25.

In the present embodiment, the result data transmission facility corresponds to the result data transmission means of the present invention and is implemented by the communications control unit 28 etc.

In the system training server 1 of the present embodiment, the program storage facility stores programs for conducting simulation regarding a number of different types of semiconductor manufacturing systems, condition data received by the condition data receive facility includes semiconductor manufacturing system type-designation data, and the program execution facility executes programs associated with the type-designation data.

The system training server 1 of the present embodiment is equipped with a manual data storage facility for storing manual data related to semiconductor manufacturing systems, a manual data request data receive facility for receiving manual data request data input to the user PC 31 by the user and transmitted from the user PC 3 via the Internet 5, and a manual data transmit facility for retrieving the manual data requested by the received manual data request data and sending the retrieved data to the user PC 3 over the Internet 5.

In the present embodiment, the manual data storage facility corresponds to the manual data storage means of the present invention and is implemented by the manual data database 22.

In the present embodiment, the manual data request data receive facility corresponds to the manual data request data receive means of the present invention and is implemented by the communications control unit 28 etc.

In the present invention, the manual data transmit facility corresponds to the manual data transmit means of the present invention and is implemented by the communications control unit 28 etc.

The system training server 1 of the present embodiment is equipped with a user identification data receive facility for receiving user identification data (user ID and password data in this embodiment) input to the user PC 3 by the user and transmitted from the user PC 3 via the Internet 5, a user verify facility for verifying users based on the received user identification data, and an access restrict facility for restricting user access based on the verification result.

In the present embodiment, the user identification data receive facility corresponds to the user identification data receive means of the present invention and is implemented by the communications control unit 28 etc.

In the present embodiment, the user verify facility corresponds to the user verify means of the present invention and is implemented by the CPU 26, the memories 24 and 25, and the customer information database 23 (data stored therein).

In the present embodiment, the access restrict facility corresponds to the access restrict means of the present invention and is implemented by the CPU 26 and the memories 24 and 25.

The system training server 1 of the present embodiment is equipped with an expiration date data storage facility for storing expiration date data related to user access. The access restrict facility restricts user access based on the verification result of the user verify facility and the expiration date data stored in the expiration date data storage facility.

In the present embodiment, the expiration date data storage facility corresponds to the expiration date data storage means of the present invention and is implemented by the customer information database 23.

The system for providing training in semiconductor manufacturing system operation techniques according to the present invention encrypts data exchanged between the system training server 1 and the user PC 3 (in this embodiment, training data for conducting training) on the transmitting side and decrypts the data on the receiving side.

In financial institution monetary and online securities transactions, for example, password management and an encription SSL (secure sockets layer; 64 or 128 bit) is utilized.

In the present embodiment, the user PC 3 is equipped with an input facility (keyboard, mouse or the like) that the user uses to input various data and instructions, display facility (a display screen or the like) for displaying various data to the user, and a communications facility for exchanging data with the system training server 1 over Internet 5.

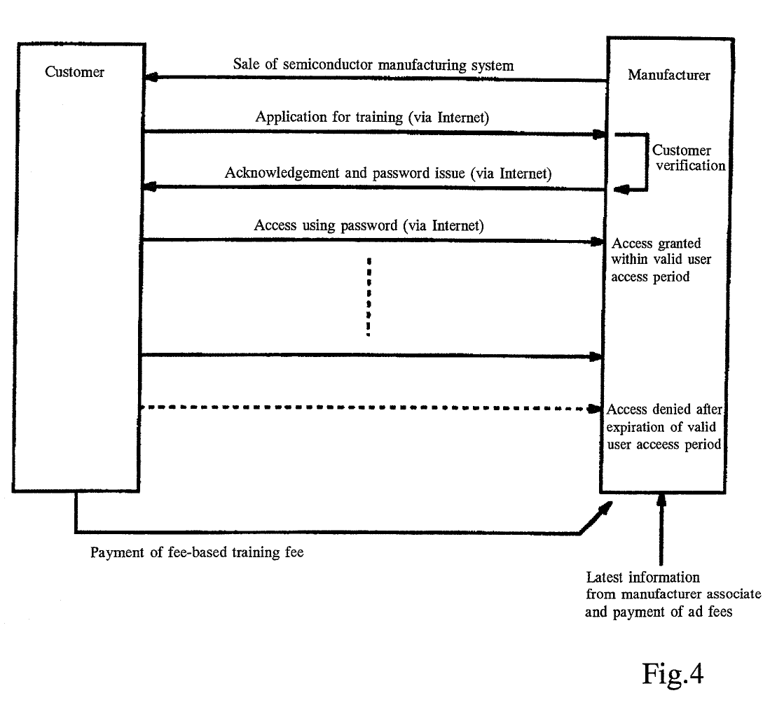

An example of the operation of the system for providing training in semiconductor manufacturing system operation techniques of the present embodiment will now be explained with references to FIGS. 4 to 10.

FIG. 4 schematically illustrates an example of the operation of the system for providing training in semiconductor manufacturing system operation techniques according to the present embodiment.

In the present embodiment, the manufacturer first sells a semiconductor manufacturing system to the customer and the customer uses the user PC 3 to apply for training by accessing the system training server 1 over the Internet 5.

After the system training server 1 has verified the customer that submitted the application for training, it creates an acknowledgement, issues a password and sends both to the user PC 3 via the Internet 5.

Once the password has been issued in this manner, the customer can receive semiconductor manufacturing system operation training by using the password to access the system training server 1 from the user PC 3 over the Internet 5.

In the present embodiment, the customer can, as mentioned earlier, access the system training server 1 to receive free training within the valid user access period established for the customer. After valid user access period has expired, this type of access is denied but the user can, by paying the manufacturer a fee, thereafter receive fee-based training.

In addition, the manufacturer can receive up-to-date information from its business associates and also receive ad fees. These ad fees and the fees paid by customers for fee-based training are the main sources of income used for operating the system for providing training in semiconductor manufacturing system operation techniques.

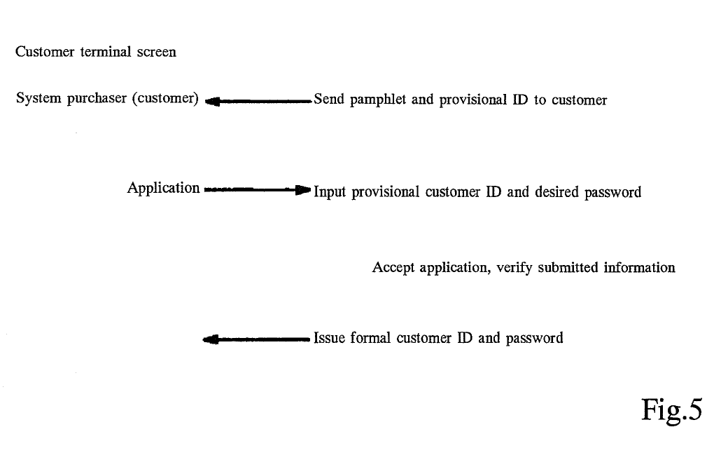

FIG. 5 shows an example of the procedure followed when a customer that has purchased a semiconductor manufacturing system applies for semiconductor manufacturing system use training. The application can be made online between the user PC 3 and the system training server 1, in which case the user inputs data and instructions related to the application to the user PC 3 while viewing the screen of the user PC 3.

Specifically, the customer first downloads a pamphlet regarding training from the manufacturer's system training server 1 and receives a provisional customer ID (provisional user ID). The customer then uses the provisional ID to send a desired password and the like to the system training server 1. Upon receiving the application from the customer and verifying the information input by the customer, the system training server 1 issues the customer a formal ID and password.

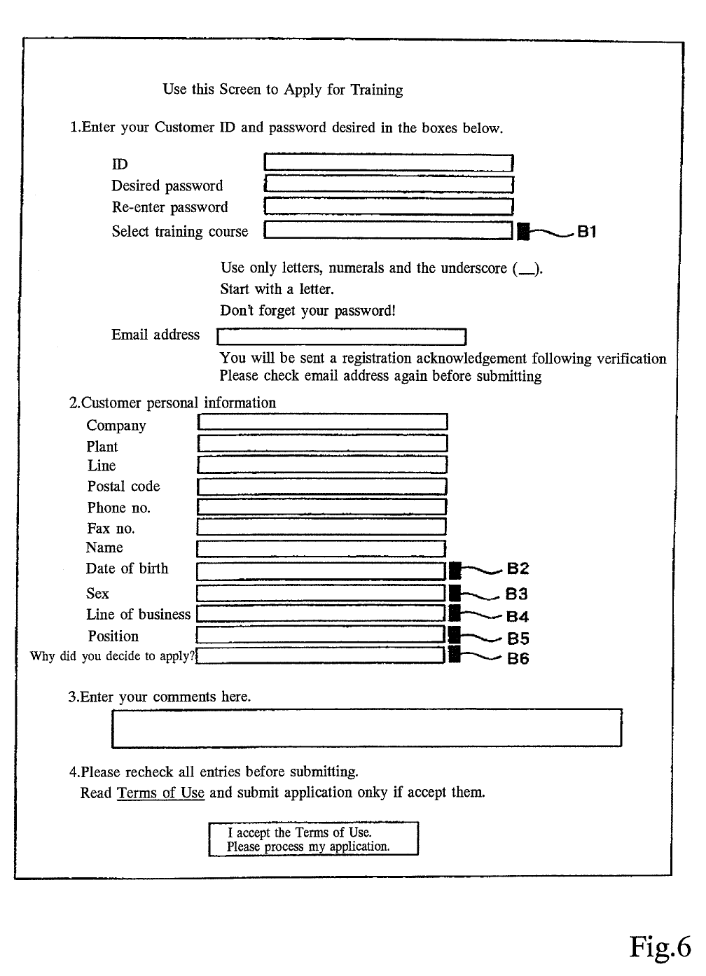

FIG. 6 shows an example of a training application (signup) screen used by a customer to apply to the manufacturer for semiconductor manufacturing system operation training. The system training server 1 sends the illustrated application form over the Internet 5 for display on the screen of the user PC 3.

As shown in FIG. 6, the training application screen includes boxes for inputting a “(Provisional) customer ID,” “Desired password” and “Selected training course.” It also includes boxes for inputting a “Mail address” and user personal information such as “Company name,” “Plant name” and “Line name” and so forth. Buttons B1 to B6 are provided for displaying lists from which the customer can select applicable items.

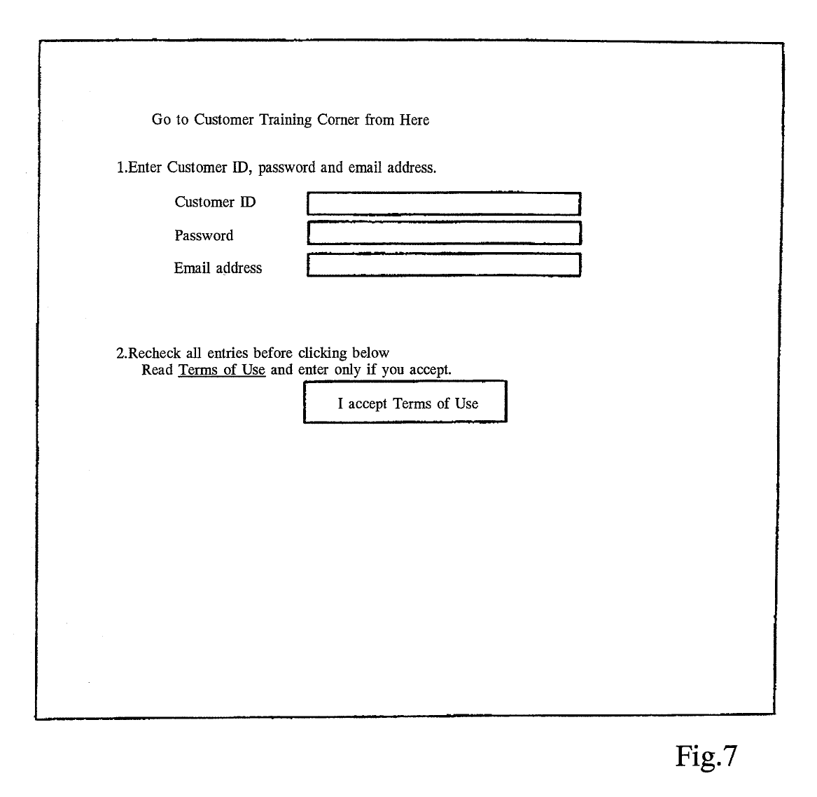

FIG. 7 shows an example of a training comer entry screen used by a customer to receive semiconductor manufacturing system operation training from the manufacturer. The system training server 1 sends the illustrated screen over the Internet 5 for display on the screen of the user PC 3.

As shown, the training corner entry screen includes boxes for entering the “Customer ID,” “Password,” and “Email address.”

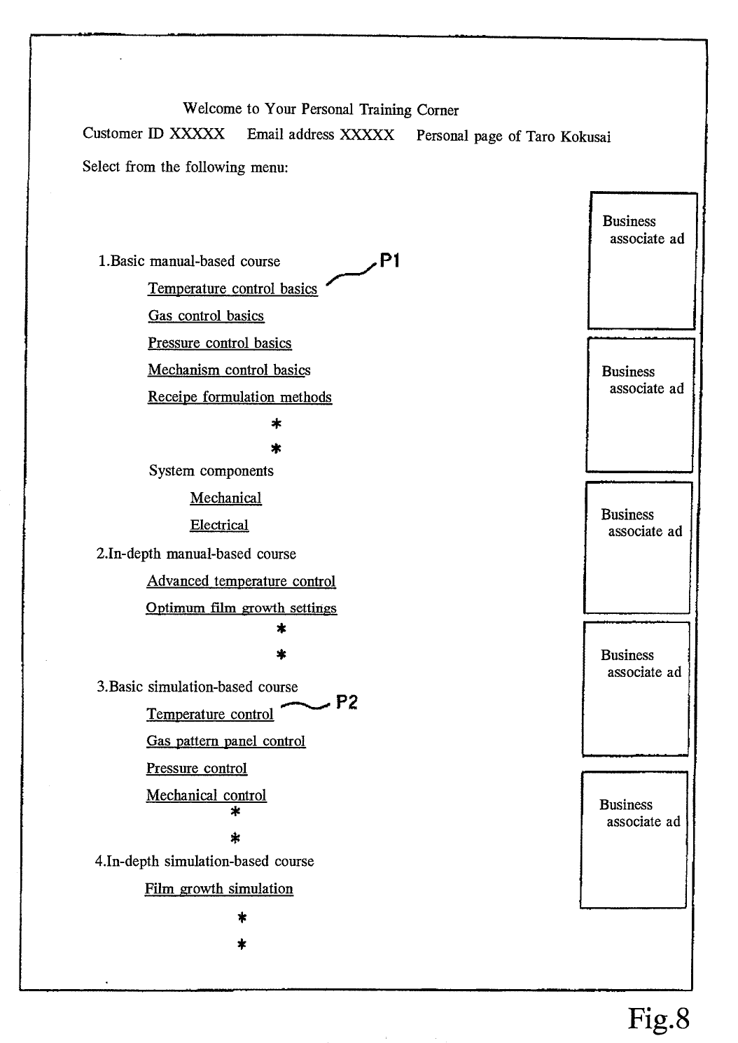

FIG. 8 an shows an example of a training corner screen used by a customer to receive semiconductor manufacturing system operation training from the manufacturer. The system training server 1 sends the illustrated screen over the Internet 5 for display on the screen of the user PC 3.

As shown, the training comer screen includes various menu items related to “Basic manual-based course,” “In-depth manual-based course,” “Basic simulation-based course” and “In-depth simulation-based course.” By clicking a desired one of the items under the course headings (e.g., by mouse-clicking an underlined item such as “Temperature control basics” P1 or “Temperature control” P2), the customer can receive training related to the clicked menu item (obtain manual data or simulation-based instruction). In addition, ads placed by business associates of the manufacturer appear along one edge of the training corner screen.

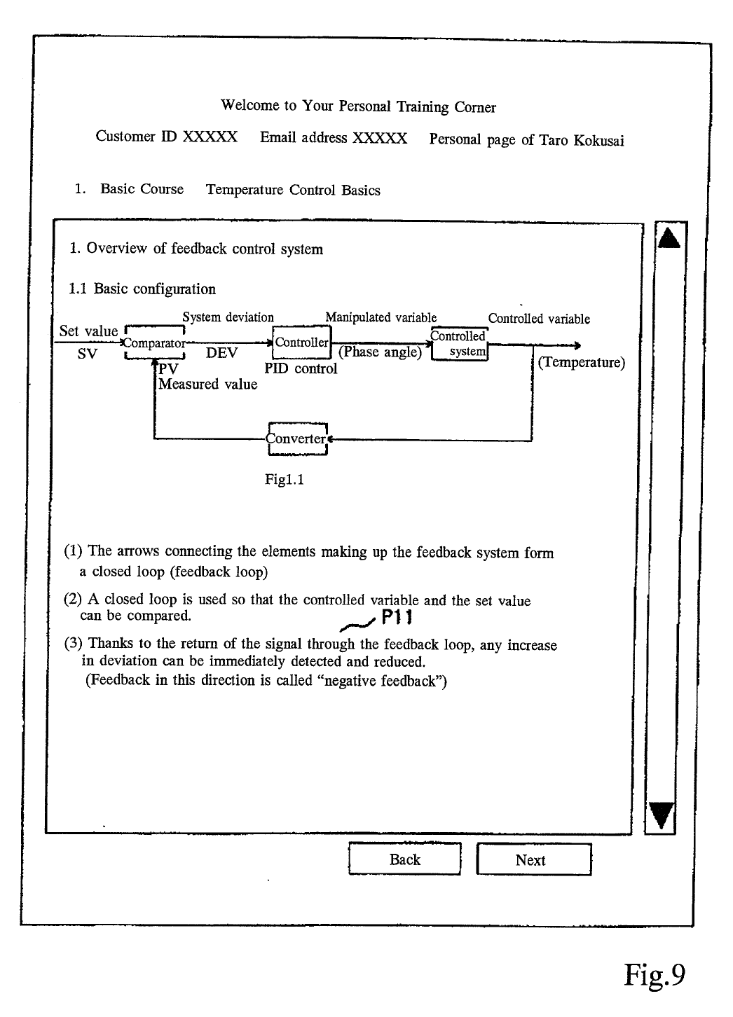

FIG. 9 an shows an example of the training corner screen of the basic manual-based course offered a customer who clicks “Temperature control basics” P1 on the screen shown in FIG. 8. The system training server 1 sends the illustrated screen over the Internet 5 for display on the screen of the user PC 3.

As shown in FIG. 9, the training corner screen of the basic manual-based course (and also the in-depth manual-based course) includes explanatory information regarding the menu item selected (clicked) by the customer. In addition, the customer can obtain more detailed information regarding special technical terms appearing on the screen (an underlined term such as “deviation” P11) by clicking them with the mouse.

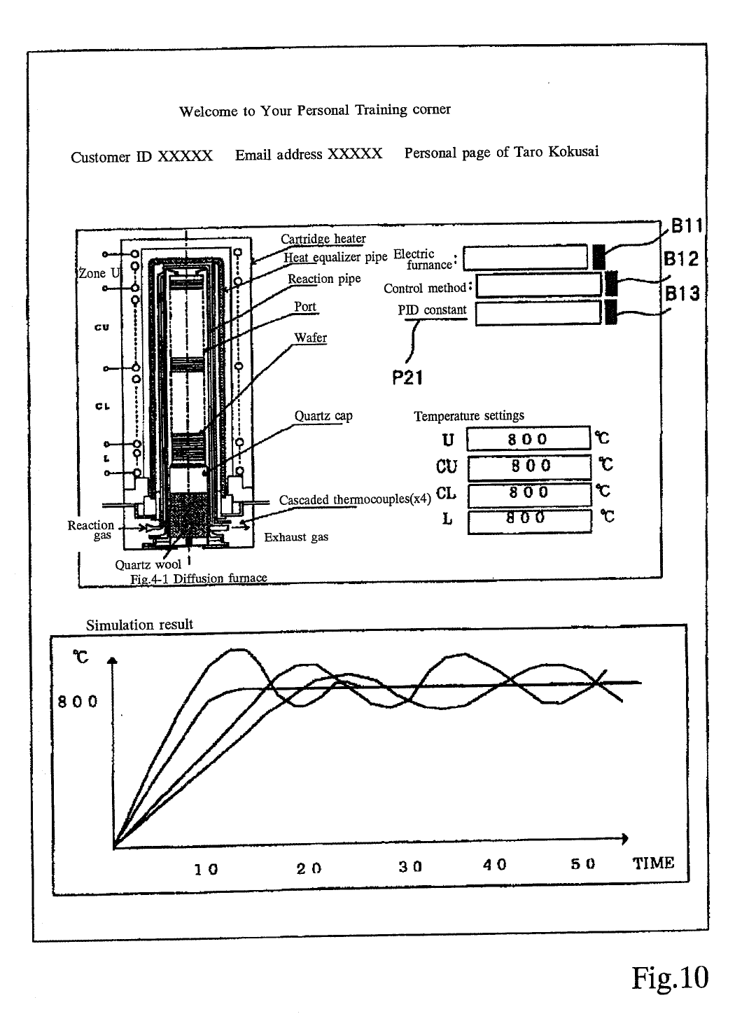

FIG. 10 shows an example of the training corner screen of the basic simulation-based course offered the customer when “Temperature control” P2 in FIG. 8 is clicked. The system training server 1 sends the illustrated screen over the Internet 5 for display on the screen of the user PC 3.

As shown in FIG. 10, the upper half of the training corner screen of the basic simulation-based course (and also the in-depth simulation-based course) displays the structure of all or part of the semiconductor manufacturing system that is the subject of simulation as well as boxes that the customer uses to enter the condition data to be used in the simulation (in the illustrated example, boxes for designating “Electric furnace,” “PID constant” P21, “Temperature settings” and the like.

When the customer clicks a specific condition data item (an underlined portion such as “PID constant” P21), a new setting screen (for setting a constant or the like related to the clicked item) appears. Select bars B11 to B13 are provided for displaying lists from which the customer can select applicable data/information.

After the customer has input the desired simulation conditions for the semiconductor manufacturing system that is the subject of simulation, the simulation is conducted and the result data produced by the simulation using the condition data is displayed on the training corner screen for the customer to view. Specifically, the condition data input by the customer is transmitted from the user PC 3 to the system training server 1 over the Internet 5, whereafter the system training server 1 carries out simulation based on the received condition data and transmits the simulation result data to the user PC 3 over the Internet 5 for display on the screen of the user PC 3.

In the illustrated example, the simulation result data received by the user PC 3 from the system training server 1 are displayed at the lower half of the screen. The simulation result in this case is displayed as a graph whose horizontal axis is scaled for time and vertical axis for temperature (° C.). The displayed simulation result is that obtained based on the condition data the customer entered in the boxes at the upper half of the screen.

Specific examples of the training the customer receives by using such simulation will now be explained with regard to temperature and pressure training and mechanical training.

Temperature training and pressure training will be taken up first.

The customer who desires one of these types of training first operates the user PC 3 to input condition data for simulation and instruct the system training server 1 to conduct simulation. As the condition data, the customer can, for example, set the PID constant, a control parameter, to a desired value, select the system type (vertical dispersion, vertical CVD, sheet-fed dispersion, sheet-fed CVD or the like), or input a temperature (or pressure) setting.

Upon input of condition data from the customer in this manner, the system training server 1 simulates the operation of the semiconductor manufacturing system that is the subject of the simulation based on, for example, electric furnace characteristics stored in memory in advance and sends the result of the simulated operation (e.g., a temperature graph or pressure graph) to the user PC 3 for display on the screen of the user PC 3.

The customer views the result data corresponding to the condition data (response waveforms or the like) on the screen of the user PC 3 and decides whether or not the result is the desired one. If not, the customer adjusts the PID constant and/or other condition data, instructs the system training server 1 to conduct another simulation, and once more studies the result data. By repeating such simulation and examination of results, the customer becomes increasingly skilled in the technique of temperature control or pressure control in the semiconductor manufacturing system.

An example of mechanical training will be explained next.

In this mechanical training, the system training server 1 displays a three-dimensional-like view of the semiconductor manufacturing system (a vertical system, for example) on the screen of the user PC 3 and enables the customer to simulate operation of the controller, handy terminal etc. in a manner virtually the same as in the case of operating a real system. The customer is therefore able to learn the operation of the system mechanisms.

The customer who wants to receive this kind of training first operates the user PC 3 to input condition data for simulation and instruct the system training server 1 to conduct simulation. As the condition data, the customer can, for example, designate different feed parameter settings, specify the recipe, implement operation (feed system operation), conduct cassette loading/unloading operations and switch operations.

Upon input of condition data from the customer in this manner, the system training server 1 simulates the operation of the semiconductor manufacturing system that is the subject of the simulation based on, for example, mechanical characteristics (feed operation characteristics) stored in memory in advance and sends the result of the simulated operation (e.g., wafer cassette movement, wafer feed, position adjustment, LED lighting and other results) to the user PC 3 for display on the screen of the user PC 3.

The customer views the result data corresponding to the condition data (semiconductor manufacturing system operation) on the screen of the user PC 3 and decides whether or not the result is the desired one. If not, the customer adjusts the condition data, instructs the system training server 1 to conduct another simulation, and once more studies the result data. By repeating such simulation and examination of results, the customer becomes increasingly skilled in the techniques of semiconductor manufacturing system mechanical operation.

Thus, as explained in the foregoing, in the system for providing training in semiconductor manufacturing system operation techniques of this embodiment, the system training server 1 trains the user in semiconductor manufacturing system operation techniques through the user PC 3 connected to the system training server 1 via the Internet 5. Effective training can therefore be conducted.

Moreover, in the system for providing training in semiconductor manufacturing system operation techniques of this embodiment, since the user is trained using simulation related to a semiconductor manufacturing system without using an actual semiconductor manufacturing system, the user can receive training with an identical “feel” to that of training by use of a real system without needing to be concerned about damaging the system. And since there is no fear of breaking equipment, the user is encourage to be venturesome in trying various operations. The user can also receive online training through simulated trouble and troubleshooting. In addition, the user can receive precisely tailored training that accurately expresses (simulates) the particulars of each of various types of semiconductor manufacturing systems with careful attention to every detail.

Since the system for providing training in semiconductor manufacturing system operation techniques according to this embodiment trains the customer using the circuit 5, it offers benefits over the conventional system requiring trainees to visit a training center, such as reduction of economic burden (e.g., travel costs), substantially total elimination of training related travel time, and lower trainee related personnel costs. For the same reason, the system for providing training in semiconductor manufacturing system operation techniques makes it possible to offer users training in the latest techniques and to provide training to a large number of customers at any time.

In the system for providing training in semiconductor manufacturing system operation techniques of the present embodiment, information on how users are utilizing the training services can be collected and analyzed on the side of the system training server 1 (i.e., by the manufacturer). Such information is useful to the manufacturer for ascertaining user requirements, developing future products and improving quality control. While simulation programs are generally very large (require large disk and memory capacity to run), in the system for providing training in semiconductor manufacturing system operation techniques according to this embodiment the simulation programs are stored in and executed by the system training server 1 on the manufacturer side and, therefore, the load on the user PC 3 side is minimized. The configuration according to the present embodiment, which conducts simulation on the side of the system training server 1 connected to the user PC 3 via a circuit (the Internet 5 in this embodiment) is therefore highly effective from the viewpoint of both the manufacturer that provides the training and the user that receives it.

The system for providing training in semiconductor manufacturing system operation techniques and its system training server and user terminal are not limited to the configurations set out in the foregoing but can be configured in any of various ways.

Moreover, the field of application of the present invention is not limited to that set out in the foregoing and the present invention can be applied in a broad range of fields.

In configuration according to the foregoing embodiment, the different types of control processing conducted in the system for providing training in semiconductor manufacturing system operation techniques of the present invention (by the system training server and user terminal provided therein) are conducted in hardware resources equipped with a processor, memories and the like, specifically by a processor that executes control programs stored in ROM. Alternatively, however, it is possible adopt a configuration in which the different means for executing the processing are independent hardware circuits.

In addition, the present invention may also be understood as the above control program (itself) or as a floppy disk, CD-ROM or other computer-readable recording media in which the control program is stored so that the processing according to the present invention can be implemented by loading the control program from the recording medium into a computer and executing the program by a processor.

As explained in the foregoing, the present invention provides a system for providing training in semiconductor manufacturing system operation techniques in which a system training server and a user terminal are interconnected via a circuit, the system training server stores at least one program for conducting simulation related to a semiconductor manufacturing system, receives simulation condition data related to a semiconductor manufacturing system that were input to the user terminal by the user and transmitted from the user terminal via the circuit, executes the stored program based on the received condition data, and transmits result data of the simulation conducted by the executed program to the user terminal via the circuit. Since the user is therefore trained by providing the user with the result data through the user terminal, the foregoing various effects can be realized and effective training can be conducted.

What is claimed is:

1. A system for providing training in semiconductor manufacturing system operation techniques including a system training server, a user terminal and a network interconnecting the system training server and the user terminal, the system training server being adapted to train the user in semiconductor manufacturing system operation techniques through the user terminal, in which system the system training server comprises:
program storage for storing at least one program for conducting simulation related to a semiconductor manufacturing system;
condition data receiver for receiving simulation condition data related to the semiconductor manufacturing system that were input to the user terminal by the user and transmitted from the user terminal via a network:
program execution device for executing the program stored in the program storage based on the received condition data; and
result data transmitter for transmitting result data of the simulation conducted by the executed program to the user terminal via the network to train the user in semiconductor manufacturing system operation techniques.

2. A system for providing training in semiconductor manufacturing system operation techniques including a system training server, a user terminal and a network interconnecting the system training server and the user terminal, the system training server being adapted to train the user in semiconductor manufacturing system operation techniques through the user terminal, in which system the system training server comprises:
program storage for storing programs for conducting simulation related to semiconductor manufacturing systems that are associated with two or more types of semiconductor manufacturing systems;
condition data receiver for receiving simulation condition data related to a semiconductor manufacturing system and including semiconductor manufacturing system type-designation data that were input to the user terminal by the user and transmitted from the user terminal via a network:
program execution device for executing based on the received condition data a program stored in the program storage associated with the type-designation data; and
result data transmitter for transmitting result data of the simulation conducted by the executed program to the user terminal via the network to train the user in semiconductor manufacturing system operation techniques.

3. A system according to claim 1, wherein the system training server further comprises:
manual data storage for storing manual data related to at least one semiconductor manufacturing system;
manual data request data receiver for receiving manual data request data that were input to the user terminal by the user and transmitted from the user terminal via a network; and
manual data transmitter for retrieving from the manual data storage manual data requested by the received manual data request data and transmitting them to the user terminal via the network.

4. A system according to claim 2, wherein the system training server further comprises:
manual data storage for storing manual data related to at least one semiconductor manufacturing system;
manual data request data receiver for receiving manual data request data that were input to the user terminal by the user and transmitted from the user terminal via a network; and
manual data transmitter for retrieving from the manual data storage manual data requested by the received manual data request data and transmitting them to the user terminal via the network.

5. A system according to claim 1, wherein the system training server further comprises:
user identification data receiver for receiving user identification data that were input to the user terminal by the user and transmitted from the user terminal via the network;
user verify device for verifying a user based on the user identification data; and
access restrict device for restricting user access based on the verification result.

6. A system according to claim 2, wherein the system training server further comprises:
user identification data receiver for receiving user identification data that were input to the user terminal by the user and transmitted from the user terminal via the network;
user verify device for verifying a user based on the user identification data; and
access restrict device for restricting user access based on the verification result.

7. A system according to claim 3, wherein the system training server further comprises:
user identification data receiver for receiving user identification data that were input to the user terminal by the user and transmitted from the user terminal via the network;
user verify device for verifying a user based on the user identification data; and
access restrict device for restricting user access based on the verification result.

8. A system according to claim 4, wherein the system training server further comprises:
user identification data receiver for receiving user identification data that were input to the user terminal by the user and transmitted from the user terminal via the network;
user verify device for verifying a user based on the user identification data; and
access restrict device for restricting user access based on the verification result.

9. A system according to claim 5, wherein the system training server further comprises:
expiration date data storage for storing the expiration date data of a valid user access period:
the access restrict device restricting user access based on the result of verification by the user verify device and the expiration date data stored in the expiration date data storage.

10. A system according to claim 6, wherein the system training server further comprises:
expiration date data storage for storing the expiration date data of a valid user access period:
the access restrict device restricting user access based on the result of verification by the user verify device and the expiration date data stored in the expiration date data storage.

11. A system according to claim 7, wherein the system training server further comprises:
expiration date data storage for storing the expiration date data of a valid user access period:
the access restrict device restricting user access based on the result of verification by the user verify device and the expiration date data stored in the expiration date data storage.

12. A system according to claim 8, wherein the system training server further comprises:
expiration date data storage for storing the expiration date data of a valid user access period:
the access restrict device restricting user access based on the result of verification by the user verify device and the expiration date data stored in the expiration date data storage.

13. A system according to any of claims 9 to 12, further comprising a training management facility for accruing and managing information related to simulation conducted by users separately for each user.

14. A training server connected with a user terminal via a network for providing a user with training in semiconductor manufacturing system operation techniques via the user terminal which comprises:
program storage for storing at least one program for conducting simulation related to a semiconductor manufacturing system;
condition data receiver for receiving simulation condition data related to the semiconductor manufacturing system transmitted from the user terminal via the network:
program execution device for executing the program stored in the program storage based on the received condition data; and
result data transmitter for transmitting result data of the executed simulation to the user terminal via the network.

15. A terminal device connected with a system training server via a network for executing a simulation program relating to a semiconductor manufacturing system stored in the system training server, the terminal device comprising:
condition data transmitter for transmitting simulation condition data received from a user and transmitting the data to the system training server via the network;
result date receiver for receiving via the circuit simulation result data of the program executed by the system training server based on the transmitted condition data; and
result output device for presenting the result data to the user.

16. A method for providing training in semiconductor manufacturing system operation techniques that trains a user by executing semiconductor manufacturing system simulation, the method comprising:
a step of inputting simulation condition data via a network to a simulation executing system for executing a simulation program related to a semiconductor manufacturing system; and
a step of receiving simulation result data produced by executing the program via the network and presenting the result data to the user.

17. A method according to claim 16, wherein the condition data includes user identification data and information related to simulation conducted by users is accrued and managed in a manner enabling output of the information separately for each user
